(19) United States
(12) Patent Application Publication
(10) Pub. No.: US 2025/0260022 A1
(43) Pub. Date: Aug. 14, 2025

(54) CORRUGATED-FLAT-TUBULAR ELECTROCHEMICAL CELL AND ITS METHOD OF MAKING

(71) Applicant: Precision Combustion, Inc., North Haven, CT (US)

(72) Inventors: Toshio Suzuki, New Haven, CT (US); Christian Junaedi, Cheshire, CT (US); Subir Roychoudhury, Madison, CT (US)

(21) Appl. No.: 19/169,575

(22) Filed: Apr. 3, 2025

Related U.S. Application Data
(63) Continuation of application No. PCT/US23/76404, filed on Oct. 10, 2023.
(60) Provisional application No. 63/415,864, filed on Oct. 13, 2022.

(51) Int. Cl. H01M 8/00; H01M 8/10

(52) U.S. Cl. CPC H01M 8/004; H01M 8/10

(57) ABSTRACT

A corrugated-flat-tubular electrochemical cell configured in a layered structure including a porous metal support layer having disposed therein a plurality of gas flow channels, a barrier layer, a fuel electrode layer, a solid oxide electrolyte layer, and an oxygen electrode layer, wherein each layer is configured in a corrugated pattern.

### CROSS-REFERENCE TO RELATED APPLICATIONS

This application is a continuation of international application no. PCT/US2023/076404, filed Oct. 10, 2023, which claims benefit of U.S. provisional application No. 63/415,864, filed Oct. 13, 2022. The contents of the aforementioned applications are incorporated in their entirety herein by reference.

### GOVERNMENT RIGHTS

The invention was made with support from the United States Government under Contract no. 80NSSC20C0308, sponsored by the National Aeronautics and Space Administration. The U.S. Government holds certain rights in this invention.

### FIELD OF THE INVENTION

This invention pertains to an electrochemical cell and to a method of making the electrochemical cell.

### BACKGROUND OF THE INVENTION

An electrochemical cell is comprised of three essential components disposed in a layered configuration: an oxygen electrode, an electrolyte, and a fuel electrode. More particularly, in a solid oxide fuel cell (SOFC) the components include the oxygen electrode functioning to reduce molecular oxygen with a source of electrons to oxide ions; the electrolyte middle layer functioning as a medium to transport the oxide ions from the oxygen electrode to the fuel electrode; and the fuel electrode functioning to oxidize a fuel feed, such as hydrogen, carbon monoxide or a mixture thereof with the oxide ions to produce, respectively, water, carbon dioxide or a mixture thereof, with concomitant production of electrons. The fuel and oxygen electrodes are connected via an external electrical circuit, such that the electrons produced at the fuel electrode traverse the circuit to the oxygen electrode while being available to do electrical work. Current and power achieved from one electrochemical cell is typically small; therefore, a collection or plurality of such cells is connected in series to form a stack of higher power output.

In order to provide structural support and strength to an electrochemical cell, a porous substrate has been used to anchor either the fuel electrode, the electrolyte, or the oxygen electrode. Fuel electrode-supported cells, in particular, exhibit higher electrochemical performance. Among various kinds of substrate materials, a porous metal has been shown to be desirable. Generally, the substrate material is selected to match chemically and electrically the layer intended to be supported, so as to maximize conductivity and reduce ohmic resistance. Additionally, the substrate material should have a coefficient of thermal expansion matched to that of the relevant cell layer, so that the cell is durable and remains intact under high operating temperatures.

The art recognizes that the geometry of an electrochemical cell plays an important part in the cell's durability and performance. Planar cells, that is, those compiled in a layered flat configuration, are well known. This type of cell offers good power output but generally fails to provide acceptable strength, thermal resistance and durability. Tubular cells, built by applying the cell layers circumferentially around an extruded cylindrical porous support, tend to provide higher strength and resistance to thermal stress as well as case of stacking; but tubular cells have reduced power density and are more costly to manufacture. Flat-tubular solid oxide fuel cells (FT-SOFCs) provide a hybrid geometry with the advantages of both flat and tubular cells. In the FT-SOFC, a flattened support layer having disposed therein a plurality of tubular gas flow channels provides both for strength and for fuel and oxygen distribution channels. A flat fuel electrode layer is typically applied to the flat-tubular support layer; and thereafter, the electrolyte and cathode layers and any other intervening barrier layers are applied as flat layers in appropriate order.

Planar cells have also been constructed with a corrugated, that is wavy, fuel or oxygen electrode layer, as described for example in U.S. Pat. No. 8,367,265. Corrugation provides a plurality of gas flow channels for distributing fuel or oxygen feed streams. Also, corrugation can provide improved strength, higher surface area, and increased reaction sites at the fuel or oxygen electrode layer.

The manufacture of an electrochemical cell continues to be the object of considerable research. One goal aims to provide for structural strength, while also minimizing the weight of each individual cell repeat unit in a stack. Another goal aims to provide for gas manifolds simply without undue complexity of design. Another goal aims to provide for a cell that tolerates elevated gas pressure differentials between anode and cathode gases. Another goal is to manufacture the electrochemical cell with a high degree of integrity and reproducibility with a minimum of complex steps and cost. In any case, the cell should achieve these goals without sacrificing power density or output.

### SUMMARY OF THE INVENTION

In one aspect, this invention provides for a corrugated-flat-tubular solid oxide electrochemical cell comprising in a sandwich configuration:
(a) a porous metal support layer configured with a plurality of gas channels;
(b) a barrier layer;
(c) a fuel electrode layer;
(d) a solid oxide electrolyte layer; and
(e) an oxygen electrode layer;
wherein each of the aforementioned layers is configured in a corrugated structure. We refer to the aforementioned corrugated-flat-tubular solid oxide electrochemical cell as “asymmetrical,” so as to distinguish it from a “symmetrical” cell of our invention described hereinbelow.

This invention also provides for a method of preparing the aforementioned corrugated-flat-tubular solid oxide electrochemical cell, the method comprising:
(a) providing a green metal support sheet comprising particles of a support material and particles of a pore former;
(b) introducing a plurality of slits into the green metal support sheet;
(c) applying a green barrier layer on top of the green metal support sheet;
(d) applying a green fuel electrode layer on top of the green barrier layer;
(e) applying a green solid oxide electrolyte layer on top of the green fuel electrode layer so as to form a green half-cell composite;
(f) heating the green half-cell composite with pressure applied to the green electrolyte layer so as to form a green laminated half-cell composite;
(g) co-sintering the green laminated half-cell composite under conditions sufficient to form an electrochemical half-cell comprising in a stacked configuration the following layers: a porous metal support layer having a plurality of gas channels, a barrier layer, a fuel electrode layer, and a solid oxide electrolyte layer, wherein each layer is configured in a corrugated structure; and
(h) applying an oxygen electrode layer on top of the electrolyte layer of the half-cell, the oxygen electrode layer also configured in a corrugated structure.

In a related aspect, this invention provides for a symmetrical corrugated-flat-tubular solid oxide electrochemical cell comprising in a sandwich configuration:
(a) a porous metal support layer defining top and bottom sides, the porous metal support layer configured with a plurality of gas channels;
(b) a barrier layer disposed on each of the top and bottom sides of the porous metal support layer so as to form top and bottom barrier layers;
(c) a fuel electrode layer disposed on each of the top and bottom barrier layers so as to form top and bottom fuel electrode layers;
(d) a solid oxide electrolyte layer disposed on each of the top and bottom fuel electrode layers so as to form top and bottom solid oxide electrolyte layers; and
(e) an oxygen electrode layer disposed on each of the top and bottom electrolyte layers;
wherein each of the aforementioned layers is configured in a corrugated structure.

This invention also provides for a method of preparing the aforementioned symmetrical corrugated-flat-tubular solid oxide electrochemical cell, the method comprising:
(a) providing a green metal support sheet comprising particles of a metal support material and particles of a pore former;
(b) introducing a plurality of slits into the green metal support sheet;
(c) applying a green barrier layer onto each of the top and bottom sides of the green metal support sheet so as to form top and bottom green barrier layers;
(d) applying a green fuel electrode layer onto each of the top and bottom green barrier layers so as to form top and bottom green fuel electrode layers;
(e) applying a green solid oxide electrolyte layer onto each of the top and bottom green fuel electrode layers so as to form a green symmetrical half-cell composite;
(f) heating the green symmetrical half-cell composite under pressure applied to the top and bottom green solid oxide electrolyte layers so as to form a co-laminated green symmetrical half-cell composite;
(g) co-sintering the co-laminated green symmetrical half-cell composite thereby forming a symmetrical half-cell comprising a porous metal support layer having a plurality of gas channels and having stacked on top and bottom sides thereof in sequential order: a barrier layer, a fuel electrode layer, and a solid oxide electrolyte layer; wherein each of the aforementioned layers is configured in a corrugated structure; and
(h) applying an oxygen electrode layer onto each of the top and bottom electrolyte layers of the half-cell, the oxygen electrode layers also configured in a corrugated structure.

As one technical advantage, the flat-tubular-corrugated electrochemical solid oxide cell (SOC) of this invention, both of the asymmetrical and symmetrical types, employs a porous metal support (or substrate), which provides structural integrity and strength to the cell while also providing an embedded gas manifold for distribution of the fuel stream.

As another technical advantage, all layers of the electrochemical cells of this invention are configured in a corrugated structure that provides for improved mechanical strength and durability under high pressure and temperature applications as well as under rapid heat cycling. In particular, as compared with prior art cells, our cell design tolerates higher pressure differentials between fuel electrode gas flow and oxygen electrode gas flow.

As another technical advantage, the electrochemical cells of this invention realize a greater surface area and more reaction sites and improved power density as compared with conventional flat solid oxide cells.

As yet another technical advantage, the electrochemical cells of this invention can minimize stack components to permit lower stack weight and higher stack specific power, expressed as Watts per kilogram (W/kg).

Finally, as yet another technical advantage, the method of this invention of fabricating our flat-tubular-corrugated solid oxide electrochemical cells combines powder metallurgy, tape casting and laminating methods that are readily amenable to commercialization.

### BRIEF DESCRIPTION OF THE DRAWINGS

FIG. 1 depicts an embodiment of an asymmetrical corrugated-flat-tubular solid oxide electrochemical cell of this invention.

FIG. 2 depicts an embodiment of a symmetrical corrugated-flat-tubular solid oxide electrochemical cell of this invention.

FIG. 3 illustrates a green symmetrical corrugated-flat-tubular solid oxide electrochemical half-cell of this invention as fabricated with slits in a porous metal support layer and with lamination.

FIG. 4 depicts a symmetrical corrugated-flat-tubular-solid oxide electrochemical half-cell of this invention after the fabrication shown in FIG. 3.

### DETAILED DESCRIPTION

As used herein, the word “layer” refers to a quasi-two-dimensional structure wherein dimensions of length and width are significantly larger than dimension of thickness. A layer also can be considered to be a sheet of one thickness of a first material that covers all or a portion of the surface of a second material. The word, as used herein, does not limit the layer to any particular geometry; for example, the layer can be in the form of a square, rectangle, hexagon, circle, ellipse, or any other shape as dictated by design. Generally, all layers in the electrochemical cell of this invention have the same shape so that they can be matched, sealed, and secured on edges and corners.

In this invention, each layer of the electrochemical cell is required to have a corrugated configuration. The word “corrugated” refers to a wavy structure comprising a plurality of peaks and troughs. The waves can have an arc shape as in a sine wave or a flattened shape as in a square wave. Other shapes are possible, as may be suitable. In one embodiment, the corrugation, or plurality of peaks and troughs, is periodic and regular in amplitude and frequency as found, for example, in a periodic sine wave. In another embodiment, the corrugated structure is nonperiodic with peaks and troughs of varying frequency. The term “frequency” refers to a number of repeating waves per unit length of the layer. In yet another embodiment, the corrugated structure is irregular with peaks and troughs of varying amplitude. The term “amplitude” refers to a maximum displacement measured from a horizontal line through zero amplitude of the flat layer to the top of a peak or bottom of a trough of the wave. In yet another embodiment, variations occur in both frequency and amplitude. As an added feature, the corrugated pattern of each layer in the cell closely matches the corrugated pattern of each adjacent layer.

The word “flat” in this invention refers to the overall macroscopic appearance and assembly of the layers as planar, excluding consideration of their microscopic corrugation. While each layer is corrugated in its detailed structure, the layers are sandwiched in a substantially planar stack, referred to as “flat.”

The word “tubular” in this invention refers to the array of gas flow channels that provide an essential feature of the metal substrate supporting the layers of the cell. These gas flow channels are formed as a result of inserting slits into the green metal support layer prior to sintering. The skilled person will appreciate that, as used generally in the art, the term “tubular” may refer to a single cylindrical gas flow channel around which cell components are layered circumferentially. In contrast, in our invention the layers are stacked flat, not cylindrically, albeit in our case with a corrugated structure to each flat layer.

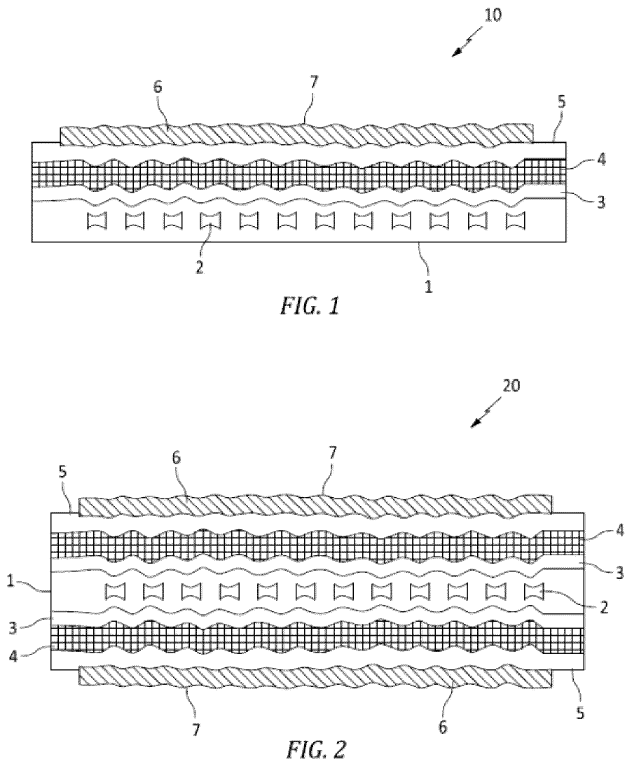

As used herein, the term “asymmetrical” refers to an electrochemical cell of this invention wherein the cell components are layered in a sandwich configuration on one side of the metal support layer. See FIG. 1 as an embodiment of an asymmetrical cell.

In contrast, the term “symmetrical” refers to an electrochemical cell wherein the cell components are layered in a sandwich configuration on top and bottom sides of the metal support layer. In this embodiment, the top and bottom cells are mirror images of each other, hence symmetrical. See FIG. 2 as an embodiment of a symmetrical cell.

Where a range is set forth in this description, the word “about” is placed before the lower limit of the range. Unless otherwise noted, the word “about” is intended to modify both the lower and upper limits of the range allowing for an acceptable variance in both lower and upper limits.

In one embodiment, this invention provides for a corrugated-flat-tubular solid oxide electrochemical cell comprising in a sandwich configuration:
(a) a porous metal support layer configured with a plurality of gas channels;
(b) a barrier layer;
(c) a fuel electrode layer;
(d) a solid oxide electrolyte layer; and
(e) an oxygen electrode layer;
wherein each of the aforementioned layers is configured in a corrugated structure having a frequency of from about 2 to 10 waves per centimeter (2-10 waves/cm) and an amplitude from about 0.1 millimeter (0.1 mm) to 0.5 mm.

In a related embodiment this invention provides for a symmetrical corrugated-flat-tubular solid oxide electrochemical cell comprising in a sandwich configuration:
(a) a porous metal support layer defining top and bottom sides, the porous metal support layer configured with a plurality of gas channels;
(b) a barrier layer disposed on each of the top and bottom sides of the porous metal support layer so as to form top and bottom barrier layers;
(c) a fuel electrode layer disposed on each of the top and bottom barrier layers so as to form top and bottom fuel electrode layers;
(d) a solid oxide electrolyte layer disposed on each of the top and bottom fuel electrode layers so as to form top and bottom solid oxide electrolyte layers; and
(e) an oxygen electrode layer disposed on each of the top and bottom electrolyte layers;
wherein each of the aforementioned layers is configured in a corrugated structure having a frequency of about 2 to 10 waves per centimeter (2-10 waves/cm) and an amplitude from about 0.1 mm to about 0.5 mm.

In yet another embodiment of any one of the foregoing embodiments of this invention, the porous metal support layer comprises a ferritic alloy containing chromium in an amount greater than 15 weight percent. In another embodiment of any one of the foregoing embodiments of this invention, the metal support layer has a porosity ranging from 20 volume percent to 50 volume percent.

In yet another embodiment of any one of the foregoing embodiments of this invention, the porous metal support layer has a thickness from 200 microns to 2,000 microns and comprises a plurality of parallel gas flow channels ranging from about 2 to 10 per centimeter (2-10/cm).

In yet another example of any one of the foregoing embodiments of this invention, the aforementioned electrochemical cell comprises a metal-supported solid oxide fuel cell or a metal-supported solid oxide electrolysis cell.

In another example of any one of the foregoing embodiments of this invention, the fuel electrode layer has a thickness between about 3 microns and 20 microns.

In another illustrative embodiment of any one of the foregoing embodiments of this invention, the fuel electrode layer comprises nickel or nickel oxide and a metal oxide selected from the group consisting of the oxides of zirconium, yttrium, cerium, scandium, gadolinium, samarium, calcium, lanthanum, strontium, magnesium, gallium, barium, and mixtures thereof. In one preferred embodiment the fuel electrode layer comprises nickel oxide-yttria-stabilized zirconia, NiO—YSZ.

In another illustrative embodiment of any one of the foregoing embodiments of this invention, the electrolyte layer has a thickness between about 1 micron and 20 microns.

In yet another illustrative embodiment of any one of the foregoing embodiments of this invention, the electrolyte layer comprises a metal oxide selected from the group consisting of the oxides of zirconium, yttrium, cerium, scandium, gadolinium, samarium, lanthanum, strontium, magnesium, gallium, barium, calcium and mixtures thereof. In one preferred embodiment, the electrolyte layer comprises yttria-stabilized zirconia.

In yet another illustrative example of any one of the foregoing embodiments of this invention, the oxygen electrode layer has a thickness between about 10 microns and 30 microns.

In yet another illustrative embodiment of any one of the foregoing embodiments of this invention, the oxygen electrode layer is selected from compositions of formula ABO₃, wherein A is selected from the group consisting of barium, strontium, lanthanum, samarium, praseodymium, and combinations thereof, and B is selected from the group consisting of iron, cobalt, nickel and manganese. In a preferred embodiment, the ABO₃ is lanthanum strontium cobalt ferrite (LaSrCoFeO₃).

In another illustrative example of any one of the foregoing embodiments of the electrochemical cell of this invention, an interlayer is disposed in between the electrolyte layer and the oxygen electrode layer, optionally further wherein the interlayer has a thickness between about 1 micron and 20 microns.

The invention can be better understood and envisioned from consideration of the Drawings. With reference to FIG. 1, an embodiment 10 is depicted of an asymmetrical corrugated-flat-tubular electrochemical cell of this invention comprised of the following components assembled in an overall flat configuration: a porous metal support layer 1 having disposed therein a plurality of tubular gas flow distribution channels 2, a barrier layer 3, a fuel electrode layer 4, a solid oxide electrolyte layer 5, and an oxygen electrode layer 6. At the surface level, each layer is configured in a corrugated wavy pattern 7, which also closely match in pattern from layer to layer. As depicted, the layers are applied onto only one side of the porous metal support 1 of cell 10.

With reference to FIG. 2, an embodiment 20 is depicted of a symmetrical corrugated-flat-tubular electrochemical cell of this invention comprised of the following components assembled in an overall flat configuration on both sides of a porous metal support layer 1 having disposed therein a plurality of tubular gas flow distribution channels 2, in the following order: a barrier layer 3, a fuel electrode layer 4, an electrolyte layer 5, and an oxygen electrode layer 6. At the surface level, each layer is configured in a corrugated wavy pattern 7, which also closely match in pattern from layer to layer. As depicted, the cell layers are applied onto both sides, top and bottom, of the porous metal support 1 of cell 20, such that the layers are mirror images of each other producing a symmetrical cell.

Typically, a half-cell of this invention, comprised of the porous metal support, the barrier layer, the fuel electrode layer, and the electrolyte layer, is fabricated by co-laminating and co-sintering a composite formed of a tape-casted green metal sheet and layers of ink-printed green cermet sheets for each of the fuel electrode, barrier, and electrolyte layers. The corrugated structure is obtained by inserting slits into the green metal sheet before applying the green cermet sheets. As a result of the slits, the surface of the co-laminated and co-sintered composite is deformed to form a corrugated shape wherein each layer has a wavy pattern closely matching adjacent layers. Moreover, as a result of its fabrication and corrugation the porous metal support is configured with a plurality of supporting columns defining a plurality of gas flow channels.

Generally, the porous metal support comprises any metallic material of acceptable strength and conductivity, which is provided as a pure metallic element or a combination of metallic elements such as in an alloy. Non-limiting examples of suitable metal supports include ferritic alloys predominantly comprising iron, and an amount of chromium greater than about 15 weight percent, and small amounts of other metallic elements. The porous metal support typically is formed into a thin sheet with a thickness ranging from about 200 microns (0.2 mm) to 2,000 microns (2 mm). More importantly, the metal support is required to be “porous”, meaning that a plurality of pores, channels, open cells, or combination thereof are present throughout and within the support, facilitating diffusion of gaseous components there through. The porosity is typically equal to or greater than about 20 volume percent, and preferably, ranges from about 20 volume percent to 50 volume percent. It should be appreciated that this “porous” attribute of the metal support is distinctly different from the gas flow channels resulting from the corrugation. The metal support comprises both a porosity throughout its volume as well as the gas flow channels resulting from corrugation.

A barrier layer is applied to the porous metal support prior to adding the fuel electrode layer. The barrier layer prohibits iron and chromium from diffusing out of the porous metal support into the fuel electrode, while also prohibiting nickel from diffusing out of the fuel electrode into the porous metal support. Diffusion of chromium and nickel disadvantageously reduces fuel electrode and support functions; therefore, the barrier layer is advantageously employed. Typically, the barrier layer comprises grains of a metal selected from the group consisting of nickel, iron, cobalt, chromium, copper, manganese, and mixtures thereof, and grains of a metal oxide wherein the metal is selected from the group consisting of cerium, gadolinium, samarium, lanthanum, yttrium, chromium, titanium, calcium, strontium, iron, nickel, cobalt, aluminum, manganese, zirconium and mixtures thereof. The grains of metal and metal oxide each independently range from submicron to micron in size. In one illustrative embodiment, the barrier layer comprises grains of a metal selected from the group consisting of nickel and copper. In another illustrative embodiment, the barrier layer comprises grains of a metal oxide wherein the metal oxide is ceria or a rare-earth doped ceria. In another illustrative embodiment, the barrier layer comprises grains of a metal oxide wherein the metal oxide is lanthanum chromite or a doped lanthanum chromite system as known in the art. In yet another illustrative embodiment, the barrier layer comprises grains of a metal oxide wherein the metal oxide is strontium titanate or a doped strontium titanate system as known in the art.

The fuel electrode layer is sufficiently porous to allow a fuel, typically a gaseous reformate comprising hydrogen and carbon monoxide, to access the electrode's catalytic sites, which function to catalyze the electrochemical half-reaction converting the fuel with oxide ions to water and carbon dioxide, respectively. Since the fuel electrode must be electrically and ionically conductive, the fuel electrode typically comprises a cermet combining a ceramic and a metal. Non-limiting examples of cermets useful as the fuel electrode layer include a composite comprising nickel or nickel oxide combined with a metal oxide wherein the metal is selected from the group consisting of zirconium, yttrium, cerium, scandium, gadolinium, samarium, calcium, lanthanum, strontium, magnesium, gallium, barium, and mixtures thereof. Some illustrative embodiments include nickel-yttria stabilized zirconia, nickel mixed with gadolinium doped ceria, and nickel mixed with yttria doped ceria zirconia.

The solid oxide electrolyte comprises a dense layer of ceramic capable of conducting oxide ions (O²⁻). Typically, the electrolyte comprises a metal oxide selected from the group consisting of scandium, cerium, zirconium, lanthanum, strontium, magnesium, gallium, barium, yttrium, gadolinium, samarium, calcium, and mixtures thereof. As an example of a material from which the solid oxide electrolyte layer can be made, we include yttria-stabilized zirconia (YSZ) and scandia-stabilized zirconia (ScSZ). As newer electrolytes are developed, these may lead to more robust materials and less resistivity problems by improving the conductivity of oxide ions, which in turn may lead to better performing electrolyte layers, any of which may be employed in this invention.

In one embodiment, an interlayer is disposed in between the electrolyte layer and the oxygen electrode layer. Typically, the interlayer has a thickness between about 1 micron and 20 microns. The interlayer functions to retard reaction between the electrolyte and the oxygen electrode or cathode materials. Typically, the interlayer comprises one or more rare earth elements doped with one or more metals selected from Group IIA elements. In one embodiment, the rare earth elements are selected from lanthanum, samarium, yttrium, gadolinium, and combinations thereof. In one embodiment, the interlayer is comprised of a rare-earth doped ceria.

The oxygen electrode should also be porous so as to provide for a uniform gas flow of oxygen throughout the electrode and should be capable of conducting oxide ions (O⁻²) to the solid oxide electrolyte. As non-limiting examples of a material from which the oxygen electrode can be formed, we include those of formula ABO₃, wherein A is selected from the group consisting of barium, strontium, lanthanum, samarium, praseodymium, and combinations thereof, and B is selected from the group consisting of iron, cobalt, nickel, manganese, and mixtures thereof. Some illustrative embodiments include manganese-modified-yttria-stabilized zirconia (Mn—YSZ), lanthanum strontium manganite (LSM), lanthanum strontium ferrite (LSF) and any of the cobalites.

The asymmetrical electrochemical half-cell comprising the porous metal substrate, the barrier layer, the fuel electrode, and the electrolyte is fabricated by powder metallurgy and tape-casting methods to form a stack of green layers, which is then co-laminated and co-sintered. After the half-cell is fabricated, a green oxygen electrode layer is ink printed onto the top electrolyte layer, and the resulting composite is co-laminated and co-sintered to form the compete electrochemical cell. More specifically, the half-cell is fabricated by tape casting a green metal sheet, followed by ink printing green cermet sheets of the barrier layer, the fuel electrode and electrolyte layers, after which the resulting green composite is co-laminated and then conveniently co-sintered.

As a method of tape-casting the green metal support sheet, a slurry is prepared comprising a solvent, a powdered form of the desired metallic support element, alloy or precursor thereto, a pore former, and optionally, at least one additional component selected from a binder, a plasticizer and a dispersant. The slurry is tape cast into a sheet ranging in thickness from about 200 microns to 2,000 microns, preferably, from about 200 microns to 500 microns. Typically, the solvent comprises an organic compound that is liquid at ambient temperature and pressure, preferably, such solvent having a low boiling point so as to be easily vaporized. Non-limiting examples of suitable solvents include common organic solvents removable at a temperature between 50° C. and 120° C. Such solvents include alcohols, esters, and ketones; and these generally are supplied to the slurry in an amount ranging from about 5 to 20 weight percent, based on the total weight of the slurry or ink. Desirably, the powdered form of the selected metallic element, alloy or precursor thereto has an average particle size ranging from about 1 micron (1 μm) to 20 microns (20 μm). The pore former is any material that on sintering is destroyed, leaving behind cavities or holes of a desired diameter (or size). The pore former is used in an amount that generates the desired porosity. Generally, the substrate has a porosity ranging from about 20 volume percent to 50 volume percent. Typical pore formers include the following non-limiting species: starch and polymethylmethacrylate (PMMA) and well as other plastic beads of appropriate diameter. The binder is selected from commercial binder formulations, for example, alcohol and polyvinyl-based binders, in an amount ranging from about 5 to 20 weight percent. Suitable plasticizers include those from phthalate and glycol groups, added typically in an amount ranging from about 1 to 10 weight percent. Suitable dispersants include fish oil and amine groups provided in an amount ranging from about 1 to 10 weight percent. The slurry thusly-formed is tape-cast into a green metal support sheet.

After tape-casting the green metal support sheet, slits of the desired gas flow pattern frequency and amplitude are created by means of any suitable slitting method including laser cutting, knife edge cutting, scratching, or punching. The slits typically run from one end of the sheet to its opposite end so as to provide in finished form a flow pattern from an inlet end to an outlet end. In one embodiment, the slits are typically separated equidistantly apart, preferably, from about 1.0 millimeters (1.0 mm) to 5 millimeters (5 mm) separation across the green support sheet. This correlates in the finished porous metal support to a frequency of parallel gas flow channels ranging from about 2 to 10 per centimeter (2/cm-10/cm). In one embodiment, the slits are cut to a depth of about 0.1 millimeter (0.1 mm) to about 1.0 mm. This invention, however, is not limited to periodic and regular slit patterns, which may be varied as desired for particular design purposes. It should be appreciated that during cell fabrication the slits also produce corrugation.

Next, green cermet sheets of the barrier layer, the fuel electrode layer and the electrolyte layer are screen printed in order, starting with the barrier layer being laid over the green metal support sheet. Each cermet layer has a thickness ranging from about 10 microns (10 μm) to 20 microns (20 μm). The metallic and ceramic components of each cermet layer are provided in particle sizes ranging from submicron to micron as dictated by the layer design and its intended properties. Each sheet is cast as a slurry comprising a solvent, the cermet materials, and at least one component selected from a binder, plasticizer and dispersant, those materials being similar to the ones described hereinabove.

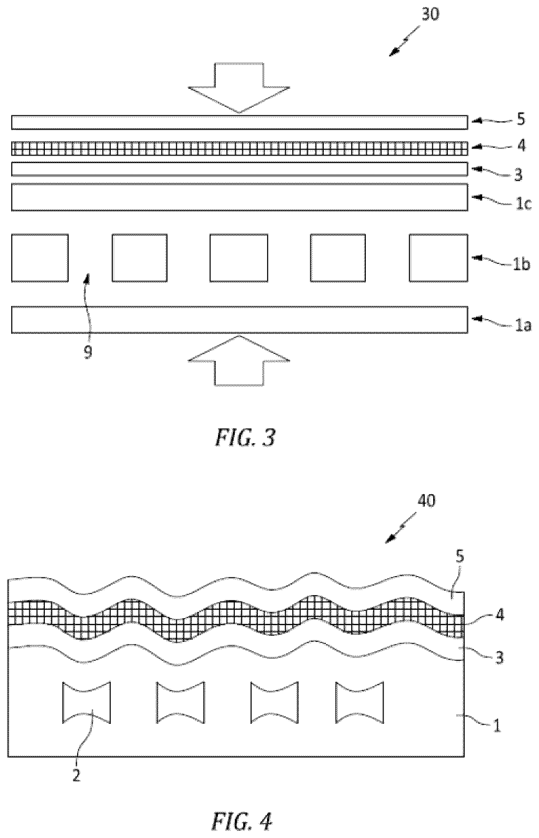

The fabrication method can be envisioned from the embodiment illustrated in FIG. 3. Here, a green half-cell composite is prepared in the following layered configuration: a first green metal support sheet 1a without slits; a second green metal support sheet 1b with a plurality of slits 9; a third green metal support sheet 1c without slits; a green barrier layer 3, a green fuel electrode layer 4, and a green electrolyte layer 5. The half-cell composite is co-laminated under pressure on the order of 3,500 kPa to 10,000 kPa. After co-lamination, the resulting co-laminated composite is subjected to a debinding step under air at a temperature between about 60° C. and 600° C. to remove organic components. Lastly, the de-bound green composite is co-sintered under a reducing atmosphere, such as a mixture of hydrogen and an inert gas, for example helium, argon or nitrogen, resulting in the corrugated-flat-tubular half-cell of this invention. The co-sintering temperature typically ranges from about 900° C. up to 1,400° C. It is an advantage of this invention that the half-cell is fabricated in only one high temperature co-sintering step.

In this invention the green metal support sheet comprises at least one layer and may comprise more than one layer. A plurality of slits are introduced into the at least one layer of the green metal support sheet and may be introduced into more than one layer as desired. The skilled person will appreciate that in the aforementioned illustration in FIG. 3, the green metal support sheet comprises three layers including a green layer with slits (1b) embedded between two green layers without slits (1a and 1c). The resulting electrochemical cell is depicted in FIG. 4, wherein the aforementioned three layers 1a-c coalesce to form the porous metal support layer 1, which is not only corrugated but also comprises a plurality of gas channels 2. The green metal support sheet is not, however, limited to three layers.

In a similar fashion, in the case of the symmetrical cell illustrated in FIG. 2, a green composite is prepared in which both top and bottom sides of the green support layer having slits are built up in sequential order with the green barrier layer, the fuel electrode layer and the electrolyte layer. Thereafter, the cell is laminated under pressure on top and bottom sides, followed by debinding and co-sintering as described hereinabove.

After preparation of the half-cell, a green oxygen electrode layer is ink printed on top of the electrolyte layer (or layers in the case of the symmetrical cell). The green oxygen electrode layer is prepared by ink printing a slurry containing the oxygen electrode materials, a solvent and at least one of a binder, dispersant, and plasticizer. In the final steps, the organics are debound and the green full cell is co-sintered to densify the oxygen electrode, thereby resulting in the corrugated-flat-tubular electrochemical cell of this invention.

Any individual electrochemical cell produces less than about 1 V under typical operating conditions, but most applications require higher voltages. Accordingly, for practical applications a plurality of individual electrochemical cells of this invention are connected in series to form a stack so as to obtain a higher voltage required for the application. The stack is constructed by securing each electrochemical cell between two interconnects that provide strength to the stack and separate the cells from each other.

Since the interconnects are exposed at high temperatures to both oxidizing and reducing sides of the cell, the interconnects should be stable under both oxidizing and reducing conditions. Accordingly, the interconnects are comprised of an electrically conductive material that is able to withstand the thermal and chemical environments to which they are exposed. In one embodiment, the interconnects are constructed of metallic plate or foil, for example, high temperature stainless steel alloys. In another embodiment, the interconnects are constructed from cermets providing for acceptable thermal stability and electrical conductivity. This invention is not limited to any particular interconnect material or interconnect layer thickness.

While the invention has been described in detail in connection with only a limited number of embodiments, it should be readily understood that the invention is not limited to such disclosed embodiments. Rather, the invention can be modified to incorporate any number of variations, alterations, substitutions, or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description but is only limited by the scope of the appended claims.

1. A corrugated-flat-tubular solid oxide electrochemical cell comprised in a following layered configuration:
(a) a porous metal support layer configured with a plurality of tubular gas channels;
(b) a barrier layer;
(c) a fuel electrode layer;
(d) a solid oxide electrolyte layer; and
(e) an oxygen electrode layer;
wherein each of the aforementioned layers is configured in a corrugated structure.

2. The corrugated-flat-tubular solid oxide electrochemical cell in accordance with claim 1 comprising a metal-supported solid oxide fuel cell or a metal-supported solid oxide electrolysis cell.

3. The corrugated-flat-tubular solid oxide electrochemical cell in accordance with claim 1 wherein each corrugated layer has from 2 to 10 waves per centimeter with an amplitude ranging from 0.1 to 0.5 millimeter.

4. The corrugated-flat-tubular solid oxide electrochemical cell in accordance with claim 1 wherein the metal support layer has a thickness of from 200 microns to 2,000 microns and a porosity ranging from 20 volume percent to 50 volume percent.

5. The symmetrical corrugated-flat-tubular solid oxide electrochemical cell in accordance with claim 1 wherein the metal support layer is configured with from 2 to 10 tubular gas channels per centimeter.

6. The corrugated-flat-tubular solid oxide electrochemical cell in accordance with claim 1 wherein the metal support layer comprises a ferritic alloy containing chromium in an amount greater than 15 weight percent.

7. The corrugated-flat-tubular solid oxide electrochemical cell in accordance with claim 1 wherein the barrier layer comprises grains of a metal selected from the group consisting of nickel, iron, cobalt, chromium, copper, manganese, and mixtures thereof, and grains of a metal oxide, wherein the metal of the metal oxide is selected from the group consisting of cerium, gadolinium, samarium, lanthanum, yttrium, chromium, titanium, calcium, strontium, iron, nickel, cobalt, aluminum, manganese, zirconium and mixtures thereof.

8. The corrugated-flat-tubular solid oxide electrochemical cell in accordance with claim 1 wherein the fuel electrode layer is a cermet comprising nickel or nickel oxide and a metal oxide selected from the group consisting of the oxides of zirconium, yttrium, cerium, scandium, gadolinium, samarium, calcium, lanthanum, strontium, magnesium, gallium, barium, and mixtures thereof; or wherein the electrolyte layer comprises a metal oxide selected from the group consisting of the oxides of zirconium, yttrium, cerium, scandium, gadolinium, samarium, lanthanum, strontium, magnesium, gallium, barium, calcium and mixtures thereof; or wherein the oxygen electrode layer is selected from compositions of formula ABO₃, wherein A is selected from the group consisting of barium, strontium, lanthanum, samarium, praseodymium, and combinations thereof, and B is selected from the group consisting of iron, cobalt, nickel and manganese.

9. The corrugated-flat-tubular solid oxide electrochemical cell in accordance with claim 1 wherein the fuel electrode layer has a thickness between 3 microns and 20 microns; the electrolyte layer has a thickness between 1 micron and 20 microns; and the oxygen electrode layer has a thickness between 10 microns and 30 microns.

10. The corrugated-flat-tubular solid oxide electrochemical cell in accordance with claim 1 wherein an interlayer is disposed in between the electrolyte layer and the oxygen electrode layer, further wherein the interlayer has a thickness between 1 micron and 20 microns.

11. A method of preparing the corrugated-flat-tubular solid oxide electrochemical cell of claim 1, the method comprising:
(a) providing a green metal support sheet comprising particles of a support material and particles of a pore former;
(b) introducing a plurality of slits into the green metal support sheet;
(c) applying a green barrier layer on top of the green metal support sheet;
(d) applying a green fuel electrode layer on top of the green barrier layer;
(e) applying a green solid oxide electrolyte layer on top of the green fuel electrode layer so as to form a green half-cell composite;
(f) heating the green half-cell composite under pressure so as to form a laminated green half-cell composite;
(g) co-sintering the laminated green half-cell composite under conditions sufficient to form an electrochemical half-cell comprising in a stacked configuration the following layers: a porous metal support layer having a plurality of gas channels, a barrier layer, a fuel electrode layer, and an electrolyte layer, wherein each layer is configured in a corrugated structure;
(h) applying an oxygen electrode layer on top of the electrolyte layer of the half-cell, the oxygen electrode layer also configured in a corrugated structure.

12. The method of claim 11 wherein the green metal support sheet comprises a plurality of layers, and wherein slits are introduced into at least one of the plurality of layers.

13. A symmetrical corrugated-flat-tubular solid oxide electrochemical cell comprising in a following layered configuration:
(a) a porous metal support layer defining top and bottom sides, the porous metal support layer configured with a plurality of gas channels;
(b) a barrier layer disposed on each of the top and bottom sides of the porous metal support layer so as to form top and bottom barrier layers;
(c) a fuel electrode layer disposed on each of the top and bottom barrier layers so as to form top and bottom fuel electrode layers;
(d) a solid oxide electrolyte layer disposed on each of the top and bottom fuel electrode layers so as to form top and bottom solid oxide electrolyte layers; and
(e) an oxygen electrode layer disposed on each of the top and bottom electrolyte layers;
wherein each of the aforementioned layers is configured in a corrugated structure.

14. The symmetrical corrugated-flat-tubular solid oxide electrochemical cell in accordance with claim 13 comprising a metal-supported solid oxide fuel cell or a metal-supported solid oxide electrolysis cell.

15. The symmetrical corrugated-flat-tubular solid oxide electrochemical cell in accordance with claim 13 wherein each corrugated layer has from 2 to 10 waves per centimeter with an amplitude ranging from 0.1 to 0.5 millimeter.

16. The symmetrical corrugated-flat-tubular solid oxide electrochemical cell in accordance with claim 13 wherein the metal support layer has a thickness from 200 microns to 2,000 microns and a porosity ranging from 20 volume percent to 50 volume percent.

17. The symmetrical corrugated-flat-tubular solid oxide electrochemical cell in accordance with claim 13 wherein the metal support layer is configured with from 2 to 10 tubular gas channels per centimeter.

18. The symmetrical corrugated-flat-tubular solid oxide electrochemical cell in accordance with claim 13 wherein the metal support layer comprises a ferritic alloy containing chromium in an amount greater than 15 weight percent.

19. The symmetrical corrugated-flat-tubular solid oxide electrochemical cell in accordance with claim 13 wherein the barrier layer comprises grains of a metal selected from the group consisting of nickel, iron, cobalt, chromium, copper, manganese, and mixtures thereof, and grains of a metal oxide, wherein the metal of the metal oxide is selected from the group consisting of cerium, gadolinium, samarium, lanthanum, yttrium, chromium, titanium, calcium, strontium, iron, nickel, cobalt, aluminum, manganese, zirconium and mixtures thereof.

20. The symmetrical corrugated-flat-tubular solid oxide electrochemical cell in accordance with claim 13 wherein the fuel electrode layer is a cermet comprising nickel or nickel oxide and a metal oxide selected from the group consisting of the oxides of zirconium, yttrium, cerium, scandium, gadolinium, samarium, calcium, lanthanum, strontium, magnesium, gallium, barium, and mixtures thereof; or wherein the electrolyte layer comprises a metal oxide selected from the group consisting of the oxides of zirconium, yttrium, cerium, scandium, gadolinium, samarium, lanthanum, strontium, magnesium, gallium, barium, calcium and mixtures thereof; or wherein the oxygen electrode layer is selected from compositions of formula ABO₃, wherein A is selected from the group consisting of barium, strontium, lanthanum, samarium, praseodymium, and combinations thereof, and B is selected from the group consisting of iron, cobalt, nickel and manganese.

21. The symmetrical corrugated-flat-tubular solid oxide electrochemical cell in accordance with claim 13 wherein the fuel electrode layer has a thickness between 3 microns and 20 microns; the electrolyte layer has a thickness between 1 micron and 20 microns; and the oxygen electrode layer has a thickness between 10 microns and 30 microns.

22. The symmetrical corrugated-flat-tubular solid oxide electrochemical cell in accordance with claim 13 wherein an interlayer is disposed in between the electrolyte layer and the oxygen electrode layer, further wherein the interlayer has a thickness between about 1 micron and 20 microns.

23. A method of preparing the symmetrical corrugated-flat-tubular solid oxide electrochemical cell of claim 13, the method comprising:
(a) providing a green metal support sheet comprising particles of a metal support material and particles of a pore former;
(b) inserting a plurality of slits into the green metal support sheet;
(c) applying a green barrier layer onto each of the top and bottom sides of the green metal support sheet so as to form top and bottom green barrier layers;
(d) applying a green fuel electrode layer onto each of the top and bottom green barrier layers so as to form top and bottom green fuel electrode layers;
(e) applying a green solid oxide electrolyte layer onto each of the top and bottom green fuel electrode layers so as to form a green symmetrical half-cell composite;
(f) heating the green symmetrical half-cell composite under pressure applied to the top and bottom green fuel electrode layers so as to form a co-laminated green symmetrical half-cell composite;
(g) co-sintering the co-laminated green symmetrical half-cell composite thereby forming a symmetrical half-cell comprising a porous metal support layer having a plurality of gas channels and having stacked on top and bottom sides thereof in sequential order: a barrier layer, a fuel electrode layer, and a solid oxide electrolyte layer; wherein each of the aforementioned layers is configured in a corrugated structure; and
(h) applying an oxygen electrode layer onto each of the top and bottom electrolyte layers of the symmetrical half-cell, the oxygen electrode layers also configured in a corrugated structure.

24. The method of claim 23 wherein the green metal support sheet of step (a) comprises a plurality of layers, and wherein slits are introduced into at least one of the plurality of layers.
